(19) United States
(12) Patent Application Publication
(10) Pub. No.: US 2014/0217212 A1
(43) Pub. Date: Aug. 7, 2014

(54) Roll

(71) Applicants: Heinz Dornbierer, Uzwil (CH); David Kehrli, Rifferswil (CH)

(72) Inventors: Heinz Dornbierer, Uzwil (CH); David Kehrli, Rifferswil (CH)

(73) Assignee: Bühler AG, Uzwil (CH)

(21) Appl. No.: 14/343,420

(22) PCT Filed: Sep. 7, 2012
(86) PCT No.: PCT/EP2012/067474

§ 371 Date: Mar. 7, 2014

(30) Foreign Application Priority Data
Sep. 9, 2011 (EP) 11180797.0

(51) Int. Cl. B02C 4/44; A23G 1/12; B02C 4/30

(52) U.S. Cl. CPC B02C 4/44; B02C 4/30; A23G 1/12
USPC 241/67; 29/402.08

(57) ABSTRACT

The invention relates to a roll (1), more particularly a rotatable roll for a five-roll structure for making chocolate, having a device for controlling the temperature of the roll body by means of a temperature control medium (4). The temperature control medium (4) is sprayed against the inner wall (8) of the roll body (2) through nozzles (7) in at least one spray lance (6). The at least one temperature control medium drain is connected to a spout (9) which protrudes into the cylindrical roll body (2).

The invention relates to a roll, in particular a rotatable roll for a five-roll refiner for making chocolate, having a device for controlling the temperature of the roll body by means of a temperature control medium, a device for supplying the temperature control medium to rolls, a spout for removing temperature control medium from rolls and a method for converting rolls.

The temperature control medium is generally a fluid, for example water, which usually serves as a coolant for cooling the roll. In principle, however, the temperature control medium may also be brought to a temperature by means of which the temperature of the roll is stabilized or increased.

Such a roll is known from practice, for example from EP072504. In the case of this roll, a hollow roll body, which is arranged horizontally in the operating state, is provided and a temperature control medium is introduced into it by way of a so-called spray lance. The spray lance is arranged substantially coaxially in the roll.

The spray lance has a feed line for temperature control fluid and, distributed at a distance from one another over its length, nozzles that are substantially upwardly directed. The temperature control medium is usually sprayed by means of the spray lance against the inner wall of the roll body. The temperature control medium then trickles down on the inner wall of the roll body into the lower half thereof, where the temperature control medium collects. The heated temperature control medium or surplus temperature control medium is drawn off by way of a channel running concentrically in relation to the central longitudinal axis. Since this channel only extends to just below the axis, the roll runs approximately half full of temperature control medium.

The temperature control medium may flow by way of a return line to a thermostat, be brought there to the desired temperature once again and be passed again by way of the spray lance into the hollow roll.

Such a roll therefore has a relatively high weight during its operation, which has disadvantageous effects on the production and operating costs. For example, the roll bearings have to be adapted to the weight and to the consequently relatively high forces. The great co-moved mass also leads to increased energy consumption.

The increased consumption of temperature control medium during the operation of such rolls is also disadvantageous. If water is used for the cooling, there is the risk of calcification, at least in the case of an open cooling circuit.

The amount of temperature control medium required can be reduced if the temperature control medium is removed by way of peripheral outlet openings. The provision of such openings is extremely laborious and the openings also hinder the operation of the rolls.

Alternatively, as shown for example in DE 1 000 665 or EP 1 661 624, the temperature control medium may be passed along the inner surface of the shell by way of restricted guidance within the roll body. For this purpose, a heat sink is provided in the roll.

A disadvantage of this is that the stiffness of the roll changes as a result of the heat sink, and the heat sink itself also has a weight that has to be taken into consideration in the operation of the roll.

The invention is based on the object of providing a roll of the type mentioned at the beginning that overcomes the disadvantages of the known art and can be cooled efficiently.

The object is achieved by a roll, in particular a rotatable roll for a roll refiner for making chocolate, having an outer cylindrical roll body and a device for controlling the temperature of the roll body by means of a temperature control medium. The roll according to the invention comprises at least one temperature control medium drain for carrying away the temperature control medium out of the roll and, in particular in addition to the temperature control medium drain, at least one temperature control medium feed for feeding the temperature control medium into the roll. The drain and the feed are arranged in an end wall of the roll body, so that there is no feeding or draining through the shell of the cylinder. Draining and/or feeding may take place for example through a bearing journal of the roll, which is rotatably mounted in a corresponding bearing arranged in a bearing block. Preferably, the temperature control medium drain and/or temperature control medium feed do not rotate along with the roll.

The roll according to the invention also comprises at least one spray lance having at least one nozzle, by way of which the temperature control medium can be sprayed against the inner wall of the roll body. Preferably, a row of nozzles is arranged along the spray lance.

The spray lance is connected to the temperature control medium feed. Preferably, the spray lance is releasably connected, so that it can for example be removed for cleaning purposes or, depending on the application, a spray lance with different spraying characteristics may be used.

According to the invention, the at least one temperature control medium drain is connected, in particular releasably, to at least one spout, which protrudes, in particular freely, into the cylindrical roll body.

In particular, the spout is not embedded in the roll shell and also does not run along the roll shell.

In the present application, a spout is understood as meaning a structural element, preferably a substantially elongate structural element, through which fluid can be passed. Preferably, it is a hollow body.

Preferably, only one spout is provided, but there may also be multiple spouts protruding into the roll.

The spout is preferably a tubular or hose-like element, on one side of which, which in the fitted state is arranged at the end remote from the temperature control medium drain, there is at least one opening, through which the temperature control medium can pass from the roll body into the spout and to the temperature control medium drain. Alternatively and/or in addition, further, preferably closable, openings may be provided in the wall of the spout.

The spout may be produced from flexible material and have a flexible, hose-like character. The spout preferably has at least partially a substantially defined cylindrical form, and consequently tends to be tubular.

The spout makes it possible by suitable positioning to set the amount of temperature control medium there is in the roll.

The connection between the spout and the temperature control medium drain can be configured in such a fluid-guiding manner that temperature control medium can flow out of the spout into the temperature control medium drain.

By contrast with temperature control medium that is removed by way of temperature control medium lines which are connected to the roll body, in particular the roll shell, the temperature control medium in the spout does not have to be moved along with the roll.

In a preferred embodiment of the invention, the distance between the end of the spout that is remote from the temperature control medium drain and the inner wall of the roll body is less than the radius of the roll body, preferably less than half the radius. In particular in the operating state, the spout faces downward, so that the temperature control medium is removed from a region that lies within the lower half of the roll body. If the temperature control medium is removed quickly enough, the roll only runs full up to the height of the end of the spout.

The roll therefore clearly contains less temperature control medium than the conventional rolls, in which the temperature control medium is removed by way of a drain arranged substantially axially.

In an advantageous variant of the invention, the distance between the end of the spout that is remote from the temperature control medium drain and the inner wall of the roll body is adjustable.

The spout may, for example, have a joint and be able to be angled away with respect to the axis of the roll.

The spout may also, for example, be telescopically constructed and have a variable length.

In this way the level to which the roll body runs with temperature control medium can be controlled. The closer an end of the spout that is downwardly directed in the operating state is to the inner wall of the roll body, the less full the roll must run before draining of the temperature control medium can take place.

The efficiency of the temperature control depends on the type of temperature control medium, the difference in temperature between the temperature control medium and the roll, the number of nozzles and the also related throughput of the temperature control medium through the roll. The more nozzles are used for the spraying, the more temperature control medium can be introduced into the roll and the more uniformly the temperature control medium can be distributed over the inner wall of the roll.

For certain applications, it may be desired that the roll runs more or less full with temperature control medium. The amount can be set by way of the distance of the end of the spout from the roll.

The distance is adjustable in particular by way of the angle between a preferably tubular spout and the axis of the cylindrical body.

For this purpose, the spout, or at least the part of the spout that is remote from the temperature control medium drain, is provided in a jointed manner at the connection to the temperature control medium drain.

For insertion into the roll, the spout may be aligned coaxially in relation to the roll body. Once the spout is in the roll, it, or at least part of the spout, can be swung away until the end of the spout assumes the desired distance from the inner wall of the roll body.

For servicing purposes or for cleaning, it is therefore not necessary to remove the complete roll, but instead it is sufficient if the extended spout is pulled out through an opening in the end face of the roll body.

In a further advantageous embodiment of the roll, the temperature control medium drain and the temperature control medium feed are jointly guided axially in relation to and/or into the roll. The roll body then only needs a supply opening in one of the end faces.

Preferably, the temperature control medium drain and the temperature control medium feed are arranged in a shared tube. Then, for servicing and cleaning purposes, the temperature control medium drain and the temperature control medium feed are removed and re-fitted jointly, which facilitates these operations and reduces the time required.

The tube is preferably led axially into the roll.

Preferably, the temperature medium drain, the temperature medium feed, the at least one spray lance and the at least one spout form a structural unit, so that the temperature control medium drain, the temperature control medium feed, the at least one spray lance and the at least one spout can be fitted jointly on the roll in one step.

In an advantageous embodiment of the invention, the roll has two spray lances.

The nozzles of the spray lances are preferably respectively arranged offset in relation to one another in the axial direction. In this way, more nozzles per axial length can be arranged than on a single spray lance.

The spray lances may be equipped with nozzles that respectively have different spraying directions. For example, the spraying directions of the nozzles of the one spray lance deviate from the vertical by an angle, while the spraying directions of the nozzles of the other nozzle lance deviate from the vertical by a corresponding angle in the other direction.

As a result, temperature control medium is admitted more uniformly into the interior space of the roll body, which leads to more efficient temperature control.

The removal of the temperature control medium may take place in the manner of an overflow into connected vessels or a pump may be arranged in the draining line and provide suction removal of the temperature control medium from the roll.

Preferably, the roll has means for generating positive pressure in the interior space of the roll, in particular an air feed. The pressure makes the temperature control medium run out of the spout. The filling level of the roll body consequently does not rise above the level of the end of the spout, and the desired amount of temperature control medium in the roll body is ensured.

The air is preferably likewise introduced through an opening in the end face of the roll body.

The positive pressure may also be generated by way of a gas feed through the spray lance.

Alternatively or in addition, a line for feeding compressed air may be provided in the spout.

A positive pressure of between 0.2 and 0.8 bar, preferably between 0.5 and 0.6 bar, more preferably of approximately 0.5 bar, is generated.

In a further preferred embodiment of the roll, at least one sensor for measuring the temperature control medium filling level is provided.

The sensor may be attached to the roll shell or to an end face of the roll. Preferably, the filling level sensor is attached in such a way that it does not turn with the roll. For this purpose, it may be fastened to a sensor holder led by way of the bearing journal, or to the temperature control medium feeding line or temperature control medium draining line, for example on the spray lance.

Particularly preferably, the sensor is connected to the spout.

The sensor may also be provided in the temperature control medium draining line and/or temperature control medium feeding line.

The sensor may be, for example, an ultrasound, radar, laser or infrared sensor, with which the distance between the sensor and the surface of the temperature control medium is determined.

The sensor may be, for example, a capacitive or conductive filling level sensor.

Alternatively, the sensor may be a flowmeter, which measures the amount of temperature control medium flowing in and flowing away, whereby conclusions concerning the filling level can be drawn.

Alternatively, the spout may serve as a filling level sensor. The height of the filling level may be determined, for example, by establishing on the basis of the distance of the end of the spout from the inner shell of the roll whether liquid is running out of the spout. The height of the filling level is obtained from the distance between the end of the spout and the inner shell of the roll at which temperature control medium is still just leaving the roll or is just about leaving the roll.

A spout that can be angled away may be calibrated as a filling level sensor, in that the angles that can be set are assigned to the respective heights of the filling level.

With the filling level sensor it can be checked that there is the desired amount of temperature control medium in the roll.

With the aid of the filling level sensor, the amount of temperature control medium that is in the roll can be regulated. If, for example, the filling level exceeds a setpoint value, the internal pressure can be increased by way of an additional compressed air feed. Thus, for example, if the filling level falls below a fixed setpoint value, the fed amount of temperature control medium can be increased or the amount of removed temperature control medium can be lowered. This takes place until the filling level has the desired value again.

The object is also achieved by a device for supplying temperature control medium to rolls. The device comprises at least one temperature control medium drain for carrying away a temperature control medium from and/or out of a roll and at least one temperature control medium feed for feeding a temperature control medium to and/or into the roll. The temperature control medium feed is connected, in particular releasably, to at least one spray lance, which has at least one nozzle, by way of which the temperature control medium can be sprayed.

According to the invention, the at least one temperature control medium drain is connected, in particular releasably, to at least one spout, which in the fitted state protrudes into the roll body.

New rolls may be provided with the device. Furthermore, existing rolls may be converted, and equipped with an improved temperature control medium supply, by fitting the device according to the invention.

In an advantageous embodiment of the device according to the invention, the angle between at least one spray lance and at least one spout, or at least an end piece of the spout, is adjustable.

The device is generally fitted in such a way that the spray lance runs approximately axially with the axis of the roll, at least runs parallel to the axis of the roll, in order that uniform spraying takes place.

Preferably, the spout is extended for insertion into the roll, so that it can be inserted into a small, coaxially arranged opening of the roll and is swung away in the roll.

The angle adjustment allows the end of the spout to be brought up close to the inner shell of the roll.

Preferably, the device has an air feed for introducing compressed air into the roll body.

The entire temperature control medium supply then forms a structural unit, which can be fitted as a complete unit for servicing, cleaning and converting purposes. The device preferably has sealing means and fitting means, so that the device can be fitted onto a hollow roll as a temperature control medium supply.

The object is also achieved by a spout for removing temperature control medium from rolls. The spout is connectable to a temperature control medium drain for carrying away a temperature control medium from and/or out of a roll and the angle between the end piece of the spout and the axis of the connection and/or the axis of the distal end of the spout and the axis of the connection is adjustable.

The spout is slid or screwed onto the temperature control medium drain, so that a liquid-impermeable connection is produced.

The adjustment of the angle is made possible, for example, by way of a jointed connection between the spout and the temperature control medium drain.

In an advantageous embodiment, the spout has a spout attachment and a spout endpiece, which are jointedly connected.

The spout may also be a flexible tube, the alignment of which is variable.

The object is achieved by a method for cooling a roll, preferably as described above, the temperature control medium being passed to and/or into the roll by way of a temperature control medium feed, the temperature control medium being sprayed against the inner wall of the roll body by way of a spray lance having at least one nozzle, and the temperature control medium being transported away out of the roll body to a temperature control medium drain by way of an opening in a spout which protrudes into the roll body.

In an advantageous embodiment, a positive pressure that ensures that the temperature control medium drains out of the roll is generated in the roll. In addition or alternatively, the temperature control medium is removed by suction.

In a further advantageous embodiment, the angle of the spout with respect to the axis of the roll is set before the roll is put into operation.

The object is also achieved by a method for converting rolls, the existing temperature control medium supply first being removed and fitting of a device as described above subsequently taking place.

The invention is explained in more detail below in an exemplary embodiment on the basis of a figure, in which:

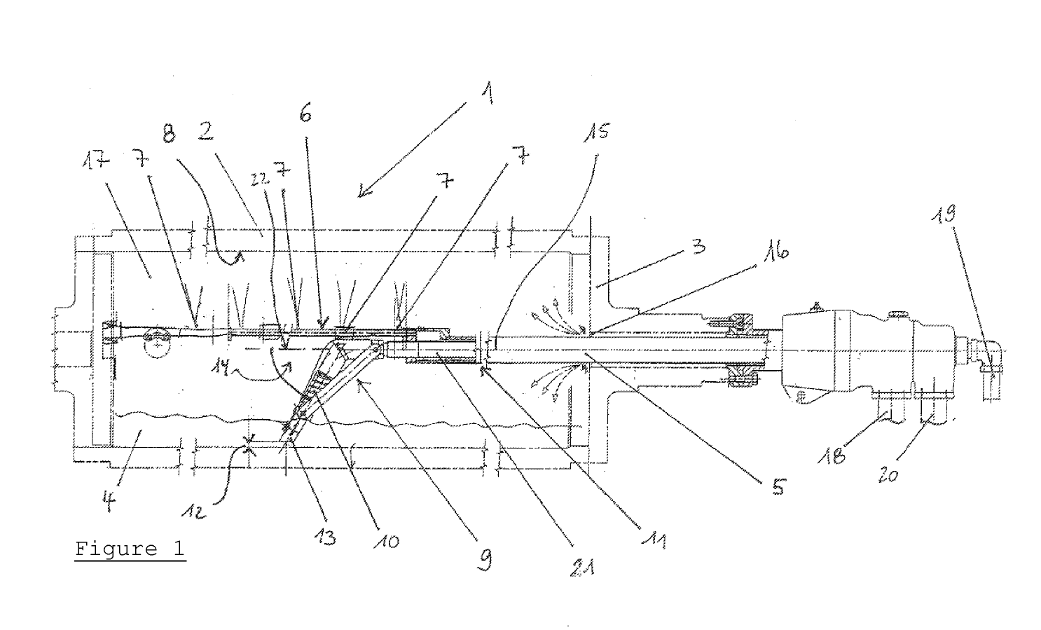

FIG. 1 shows a sectional diagram of a roll according to the invention with a first example of a spout;

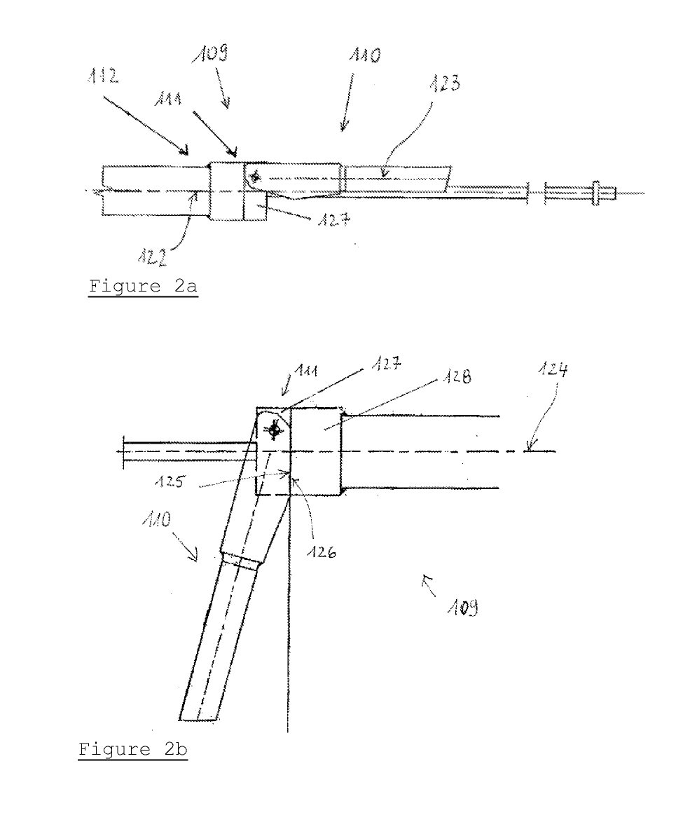

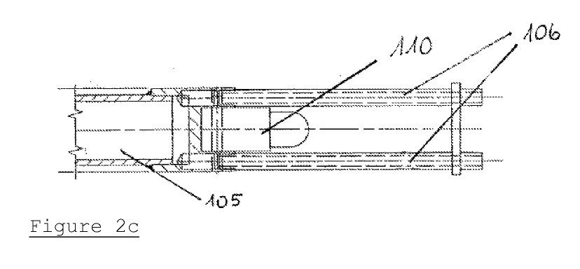

FIGS. 2a-2c show views of a second example of a spout according to the invention.

FIG. 1 shows a sectional diagram of a roll 1 according to the invention.

The roll 1 has an outer cylindrical roll body 2.

The roll body 2 is 260 cm long and has an outside diameter of 40 cm and an inside diameter of 33 cm. The material of the roll is of course heat-conducting. The roll is preferably produced from cast metal, for example gray cast iron.

A not explicitly shown temperature control medium drain, for carrying away the temperature control medium 4 out of the roll, and a likewise not explicitly shown temperature control medium feed, for feeding the temperature control medium in the roll 1, are arranged in an end wall 3 of the roll body 2.

The temperature control medium drain and the temperature control medium feed run in a shared tube 5.

The temperature control medium 4 is sprayed against the inner wall 8 of the roll body 2 by way of two spray lances 6, on which nozzles 7 are arranged in rows. The temperature control medium drain is connected to a spout 9, which protrudes into the cylindrical roll body 2.

The spout 9 has a connection 11 to the temperature control medium drain, which is located in the tube 5 but is not explicitly shown.

The distal end 10 of the spout 9 is jointedly attached to the spout attachment 21.

The distance 12 between the end 13 of the spout that is remote from the temperature control medium drain and the inner wall 8 of the roll body 2 is less than the radius of the roll body. In the position of the spout 9 that is shown in the figure, the distance 12 is approximately 1 cm. The removal of the temperature control medium 4 therefore takes place very close to the inner wall 8.

The distance 12 can be varied, in that the angle 14 between the distal end 10 of the spout and the axis 15 of the cylindrical body is adjusted. In this way, the angle between the distal end 10 of the spout and the spray lance 6, or between the distal end 13 of the spout and the axis 22 of the connection 11, is also changed at the same time.

For moving the entire temperature control means supply out of the roll body, the angle 14 may be set to 0 degrees. The spout 9 is then extended, and can be pulled out through an opening in the end wall 3.

Distributed around the tube 5, in which the temperature control medium feed and drain are located, are feed lines 16 for air. The air generates a positive pressure of approximately 0.5 bar in the interior space 17 of the roll.

The air pressure and water pressure can be regulated independently of one another.

The tube 5 with the temperature control medium feed and drain runs through the shaft of the roll 1 and has connections to a temperature control medium feeding connector 18 and a temperature control medium drainage connector 19, and also to an air feeding connector 20.

The temperature control medium 4 is circulated in a closed circuit by way of a thermostat that is not shown in the figure. The temperature control medium is inoculated to prevent contamination and/or calcification.

For example, distilled water with additives of anti-corrosive agents and/or calcification protection is used.

The temperature control medium is as low as possible in the cylinder. The end 10 of the spout has a temperature sensor, which is connected to a controller which ensures that, at a temperature that is higher than a predefined limiting temperature, the amount of inflow of temperature control medium is increased. The amount of water that is fed therefore depends on the water temperature in the region of the spout.

FIG. 2a shows a lateral view of a second example of a spout 109 according to the invention in the insertion position.

The distal end 110 of the spout 109 is attached by a joint 111 to the spout attachment 112. If the spout 109 is pushed into the roll or is pulled out from the roll, the axis of the distal end 123 has a position parallel to the axis of insertion 124, to the axis of the shared tube 105 and to the axis of the connection 122.

FIG. 2a shows a lateral view of the second example of the spout 109 according to the invention, in the operating position.

If the spout 109 is in the roll, the end of the spout 110 swings down under the effect of gravitational force to the extent allowed by the stop faces 125, 126 of the joint 111.

The spout 109 has an inner tube 127 and an outer tube 128, which are displaceable with respect to one another and can be fixed by means of a not explicitly shown thread.

When the end of the spout 110 is swung away, the inner tube 127 is fixed with respect to the outer tube 128, so that the end of the spout 110 cannot swing up freely.

Only when the spout 109 is to be pulled out again from the roll is the connection between the inner tube 127 and the outer tube 128 released; the joint 111 has some play again and the end of the spout 110 can swing up as soon as it butts against the wall of the roll while being pulled back.

FIG. 2a shows a view from above of the second example of the spout 109 according to the invention in the operating position. The spout 109 is arranged between the spray lances 106.

With a typical inside diameter of the roll of 340 mm and lengths of 1800 mm or 2400 mm, a throughput of approximately 2 m³ per hour is required for effective cooling.

1-11. (canceled)

12. A roll having an outer cylindrical roll body and a device for controlling the temperature of the roll body by means of a temperature control medium, comprising
at least one temperature control medium drain, arranged in an end wall of the roll body, for carrying away the temperature control medium at least one of from or out of the roll,
at least one temperature control medium feed, in an end wall of the roll body, for feeding the temperature control medium at least one of into or to the roll, and
at least one spray lance having at least one nozzle, by way of which the temperature control medium can be sprayed against the inner wall of the roll body,
wherein
the at least one temperature control medium drain is connected to at least one spout, which protrudes into the cylindrical roll body.

13. The roll as claimed in claim 12,
wherein
the roll is a rotatable roll for a roll refiner for making chocolate.

14. The roll as claimed in claim 12,
wherein
the distance between the end of the spout that is remote from the temperature control medium drain and the inner wall of the roll body is less than the radius of the roll body.

15. The roll as claimed in claim 14,
wherein
the distance between the end of the spout and the inner wall of the roll body is less than half the radius of the roll body.

16. The roll as claimed in claim 12,
wherein
the distance between the end of the spout that is remote from the temperature control medium drain and the inner wall of the roll body is adjustable.

17. The roll as claimed in claim 16,
wherein
the distance is adjustable by adjustment of the angle between the end of the spout that is remote from the temperature control medium drain and the axis of the cylindrical roll body.

18. The roll as claimed in claim 12,
wherein
the temperature control medium drain and the temperature control medium feed are jointly guided axially.

19. The roll as claimed in claim 18,
wherein
the temperature control medium drain and the temperature control medium feed are arranged in a shared tube.

20. The roll as claimed in claim 12,
wherein
the roll has two spray lances.

21. The roll as claimed in claim 12,
wherein
the roll has means for generating positive pressure in the interior space of the roll.

22. The roll as claimed in claim 21,
wherein
the means for generating positive pressure in the interior space of the roll is an air feed.

23. A device for supplying temperature control medium to rolls, comprising at least one temperature control medium drain for carrying away a temperature control medium at least one of from or out of a roll,
at least one temperature control medium feed for feeding a temperature control medium at least one of to or into the roll,
at least one spray lance having at least one nozzle, by way of which the temperature control medium can be sprayed,
wherein
the at least one temperature control medium drain is connected to at least one spout, which in the fitted state protrudes into the roll body.

24. The device as claimed in claim 18, wherein the angle between the spray lance and the spout is adjustable.

25. The device as claimed in claim 18, wherein the device has an air feed for introducing compressed air into the roll body.

26. A spout for removing temperature control medium from rolls, wherein the spout is connectable to a temperature control medium drain for carrying away a temperature control medium at least one of from or out of a roll and the angle between the axis of the distal end of the spout and the axis of the connection is adjustable.

27. A method for converting rolls comprising the steps of
removing the existing temperature control medium supply,
fitting a device as claimed in claim 18.
